(19) United States
(12) Patent Application Publication
(10) Pub. No.: US 2013/0266535 A1
(43) Pub. Date: Oct. 10, 2013

(54) METHYL SALICYLATE-BASED ATTRACTANTS FOR VECTORS OF CITRUS GREENING DISEASE

(71) Applicant: UNIVERSITY OF FLORIDA RESEARCH FOUNDATION, INC., Gainesville, FL (US)

(72) Inventors: Lukasz L. Stelinski, Lake Alfred, FL (US); Jared G. Ali, Ithaca, NY (US); Hans T. Alborn, Gainesville, FL (US); Rajinder Mann, Plymouth, MN (US); Kirsten Pelz-Stelinski, Lake Alfred, FL (US)

(73) Assignee: University of Florida Research Foundation, Inc., Gainesville, FL (US)

(21) Appl. No.: 13/774,112

(22) Filed: Feb. 22, 2013

Related U.S. Application Data
(60) Provisional application No. 61/601,617, filed on Feb. 22, 2012.

(51) Int. Cl. A01N 37/40

(52) U.S. Cl. CPC A01N 37/40
USPC 424/84

(57) ABSTRACT

The present invention is directed to an insect attractant having an amount of methyl salicylate effective to attract a plurality of vectors of citrus greening disease and an agriculturally acceptable carrier.

### CROSS-REFERENCE TO RELATED APPLICATIONS

This application is related to U.S. Provisional Application 61/601,617 filed Feb. 22, 2012, to which priority is claimed and whose teachings are incorporated herein.

### FIELD OF THE INVENTION

The present invention relates to insect attractants, and more particularly to attractants for vectors of Huanglongbing (HLB) (citrus greening disease), methods for monitoring infestation of citrus plants, and to methods for diverting vectors of HLB away from a predetermined citrus growth.

### BACKGROUND OF THE INVENTION

HLB is the most devastating disease of citrus worldwide. HLB affects plant phloem, causing yellow shoots, mottling, chlorosis, twig die back that result in rapid tree decline and may ultimately cause tree death. Fruit on diseased trees are misshaped, reduced in size, and are sour in taste (Capoor, 1963; Halbert & Manjunath, 2004; Bové, 2006; Dagulo, 2010). The disease is associated with either of three species of phloem-limited, noncultured, Gram-negative bacteria, Candidatus Liberibacter asiaticus (Las), Candidatus Liberibacter africanus (Laf) or Candidatus Liberibacter americanus (Lam) (Bove, 2006; Gottwald, 2010). HLB is primarily vectored by Asian citrus psyllid, Diaphorina citri Kuwayama (Hemiptera, Psyllidae); however, African citrus psyllid, Triosa erytreae, is also known to transmit the bacteria in Africa. Both psyllid species can transmit any of the three bacterial species (Gotwald, 2010). In North America, the disease is thought to be mainly caused by Ca. L. asiaticus and vectored by D. citri (Bové, 2006; Gottwald et al., 2007; Gottwald, 2010).

Current management for D. citri primarily relies on broad spectrum insecticide applications (Roger, 2008) because of a lack of known resistant cultivars (Halbert & Manjunath 2004), effective biological control agents (Qureshi & Stansly 2007) or cultural control options (Childers & Rogers 2005; Powell et al., 2007). However, insecticide use has negatively affected populations of natural enemies and has led to development of insecticide resistance (Tiwari et al., 2011). Therefore, identification of attractants may allow development of useful alternatives or supplements to conventional insecticides. Recent investigations indicate that males of some psyllid species use volatile chemicals to locate mates (Soroker et al., 2004; Wenninger et al., 2008; Guedot et al., 2009). Behavioral evidence for a female-produced volatile sex attractant was reported in pear psylla C. bidens (Soroker et al., 2004). Post-diapausing female pear psylla, Cacopsylla pyricola (Förster) produces a cuticular hydrocarbon, 13-methylheptacosane, that attracts opposite sex conspecifics (Guédot et al., 2009). Behavioral evidence of a female derived olfactory attractant for male D. citri was also shown in laboratory olfactometer assays (Wenninger et al., 2008). Furthermore, ultrastructure of olfactory sensilla on D. citri antennae suggests chemosensory functions (Onagbola et al., 2008).

### BRIEF DESCRIPTION OF THE DRAWINGS

FIG. 1 shows the response of D. citri to odors emitted from Las-infected versus non-infected citrus in a laboratory olfactometer. Bars labeled by an asterisk are significantly different (χ2 test, p<0.05). n=total number of psyllids that responded.

FIG. 2 shows the settling preference of combined non-infected and Las-infected D. citri on Las-infected versus non-infected citrus plants. Panel (A) shows response under light conditions and panel (B) shows response under dark conditions. Bars with the same letter are not significantly different (Tukey's HSD test, p<0.05).

FIG. 3 shows the movement of previously settled D. citri from Las-infected to non-infected citrus plants. Panel (A) shows response of non-infected psyllids and panel (B) shows response of Las-infected psyllids. Bars labeled with different letters are significantly different from one another (Tukey's HSD test, p<0.05).

FIG. 4 shows the feeding efficiency of D. citri on Las-infected versus non-infected citrus leaves as measured by honeydew excretion. Bars labeled with different letters are significantly different from one another (Tukey's HSD test, p<0.05).

FIG. 5 shows chromatograms displaying volatile differences between Las-infected and non-infected plants. Release of methyl salicylate is significantly greater from plants infected with Las, while release of D-limonene and methyl anthranilate is significantly greater from non-infected plants.

### DETAILED DESCRIPTION OF THE INVENTION

The present inventors have identified specific mechanisms through which a bacterial plant pathogen induces plant responses that modify behavior of its insect vector. For example, the present inventors found that Candidatus Liberibacter asiaticus, a fastidious, phloem-limited bacterium responsible for causing citrus greening disease, induced release of a specific volatile chemical, methyl salicylate, which increased attractiveness of infected plants to its insect vector, Diaphorina citri, and caused vectors to initially prefer infected plants. The insect vectors subsequently dispersed to non-infected plants as their preferred location of prolonged settling because of likely sub-optimal nutritional content of infected plants. The duration of initial feeding on infected plants was sufficiently long for the vectors to acquire the pathogen before they dispersed to non-infected plants, suggesting that the bacterial pathogen manipulates behavior of its insect vector to promote its own proliferation. The behavior of psyllids in response to infected versus non-infected plants was not influenced by whether or not they were carriers of the pathogen and was similar under both light and dark conditions. Feeding on citrus by D. citri adults also induced the release of methyl salicylate, suggesting that methyl salicylate is a cue revealing location of conspecifics on host plants. The present inventors have thus identified specific attractants, e.g., methyl salicylate, for D. citri that may have practical applications, such as for use in monitoring the presence of D. citri in specific citrus growth areas prior to insecticide application. In addition, the identified attractants may be provided as a component of an attractant composition to draw the harmful D. citri away from the target crop.

As used herein, the terms “attract” or “attractant” mean that, as a result of the presence of an attractant as described herein, a greater number of vectors of citrus greening disease are present in a defined area than would be present without the attractant.

As used herein, the term “methyl salicylate” (lauric acid) refers to methyl salicylate and derivatives or analogs thereof.

As used herein, by “effective amount,” “amount effective,” or the like, it is meant an amount effective at dosages and for periods of time necessary to achieve the desired result, e.g., attracting a plurality of vectors of citrus greening disease.

By “repel” or “repelling” as used herein, it is meant that there are less vectors of citrus greening disease in a desired area than there would have been if the attractant were not present. Repel or repelling also includes the prevention of an infestation by an action in a desired area where there are no pests present, but at least one pest would be present if not for the action taken.

By “killing” as used herein, it is meant that a composition kills the vectors of citrus greening disease (pests) and/or inhibits or reduces the growth of the vectors. The growth of a pest has been inhibited if there has been a relative reduction in the number of pests in a desired area. The growth of a pest may also be said to have been inhibited if the normal growth pattern of the pest has been modified so as to have a negative effect on the individual pest. The number of pests has been reduced by an action if there are fewer pests in a desired area than there would have been without the action.

In accordance with an aspect of the present invention, there is provided an insect attractant comprising an amount of methyl salicylate effective to attract a plurality of vectors of citrus greening disease. The methyl salicylate may be provided from any suitable source or via any synthesis method known in the art. In one embodiment, the methyl salicylate may be provided from any suitable commercial source, such as Sigma Aldrich. The amount of methyl salicylate in the attractant composition may be from 0.001 μg to 10,000 μg, and in one embodiment, and in a preferred embodiment, is from 0.001 to 100 μg.

In one embodiment, the attractant composition may comprise further components, which may be useful as attractants for vectors of citrus greening disease. For example, in one embodiment, the attractant may further comprise a compound selected from the group consisting of β-ocimene, D-limonene, methyl anthranilate, and combinations thereof. β-ocimene and D-limonene are predominant citrus volatiles released by citrus flush, foliage, and fruit [38,63-65]. Methyl anthranilate was found to be released in significantly greater quantities relative to non-infected plants and may have attractant properties.

The attractants described herein may be formulated into compositions according to known methods for formulating agricultural/horticultural compounds. In one embodiment, the methyl salicylate (and any other active compounds capable of attracting vectors of citrus greening disease) may be mixed with an appropriate agriculturally acceptable carrier, and if required, an auxiliary at a proper proportion. The resultant mixture may be subjected to dissolution, separation, suspension, mixing, impregnation, adsorption or adhesion and can be formulated into any desired forms for practical use, such as soluble concentrates, emulsifiable concentrates, wettable powders, water soluble powders, water dispersible granules, water soluble granules, suspension concentrates, concentrated emulsions, suspoemulsions, microemulsions, dustable powders, granules, tablets and emulsifiable gels. By “agriculturally acceptable carrier,” it is meant an agent that does not have a substantial detrimental effect on the activity of the active ingredients described herein.

Suitable solid agriculturally acceptable carriers include, but are not limited to, soybean flour, grain flour, wood flour, bark flour, sawing flour, tobacco stalk flour, walnut shell flour, bran, cellulose powder, a residue after plant extraction, a synthetic polymer such as a synthetic resin powder, clay (e.g., kaoline, bentonite, or acid white clay), talc (e.g., talc or pyrophyllite), silica (e.g., diatomite, silica powder, mica, activated carbon, sulfur powder, pumice, calcined diatomite, brick powder, fly ash, sand, inorganic mineral powders such as calcium carbonate and calcium phosphate, chemical fertilizers such as ammonium sulfate, ammonium phosphate, ammonoium nitrate, urea, and ammonium chloride, and compost.

Suitable liquid carriers may be one having a solvent ability or a material having no solvent ability for the components, including methyl salicylate, but having an ability to assist in the dispersion of the active ingredient compound, e.g., methyl salicylate. Exemplary liquid carriers include but are not limited to, alcohols (e.g., methanol, ethanol, isopropanol, butanol, and ethylene glycol); ketones (e.g., acetone, methylethyl ketone, methyl isobutyl ketone, diisobutyl ketone, and cyclohexanone); ethers (e.g., diethyl ether, dioxane, cellosolve, diisopropyl ether, and tetrahydrofuran); aliphatic hydrocarbons (e.g., kerosine and mineral oil); aromatic hydrocarbons (e.g. benzene, toluene, xylene, solvent naphtha, and alkylnaphthalene); halogenated hydrocarbons (e.g., dichloromethane, chloroform, carbon tetrachloride, and chlorobenzene); esters (e.g., ethyl acetate, butyl acetate, ethyl propionate, diisobutyl phthalate, dibutyl phthalate, and dioctyl phthalate); amides (e.g., dimethylformamide, diethylformamide, and dimethylacetamide); and nitriles (e.g., acetonitrile). In one particular embodiment, the agriculturally acceptable carrier comprises an agriculturally acceptable carrier oil, including but not limited to, mineral oil or a vegetable oil such as canola oil, sunflower oil, cottonseed oil, palm oil, soybean oil, and the like. In one further particular embodiment, mineral oil is provided as the agriculturally acceptable carrier.

When the insect attractant is to be in the form of an aerosol, a propellant may be added such as propane, butane, isobutane, dimethyl ether, carbon dioxide, nitrous oxide, nitrogen, and combinations thereof. Further, it is understood that the compositions of the present invention may additionally include any suitable surfactant, penetrating agent, spreading agent, thickener, anti-freezing agent, binder, anti-caking agent, disintegrating agent, anti-foaming agent, preservative, stabilizer, and the like as is desired.

In accordance with another aspect of the present invention, there is provided a method for inhibiting infestation of a citrus plant by vectors of citrus greening disease. The vectors may be, for example, the Asian citrus psyllid, Diaphorina citri (D. citri) or the African citrus psyllid, Triosa erytrae. These vectors carry at least one three species of phloem-limited, noncultures, Gram-negative bacteria, which may be one of Candidatus Libreribacter asiaticus (Las), Candidatus Libreribacter africanus (Laf), or Candidatus Libreribacter americanus (Lam). Las and Lam are transmitted by D. citri; whereas, Laf is transmitted by Trioza erytreae. In one embodiment, the method comprises identifying a target area of desired citrus plant growth and applying an amount of an insect attractant comprising methyl salicylate to an area outside of the target area effective to attract the vectors of citrus greening disease away from the target area.

The target area may be any sized area in which is desired to be free or substantially free of vectors of citrus greening disease. Typically, however, the target area is of a size with which the attractant compositions described herein are sufficiently able to pull or attract vectors of citrus greening disease away from the target area to an alternate area. The area outside of the target area is one where the vectors of citrus greening disease will not cause damage to citrus plants. The outside area may be barren, for example, or may contain vegetation (plants, trees, or other) that are not affected by the vectors citrus greening area. In another embodiment, the outside area includes artificial vegetation. Typically, the location or locations of application of the insect attractant lie a sufficient distance from the target area such that there is little possibility that the attracted vectors of citrus greening disease are drawn to the target area. For example, in one embodiment, the area outside of the target area is at least 0.0001 m, 0.1 m, 0.5 m, 1 m, 2 m, 10 m, 50 m, 100 m, or 1000 m from a point on a perimeter of the target area. It is appreciated, however, that the attractant must, however, be sufficiently close to the target area for the vectors of citrus greening disease to sense the attractant and respond thereto.

It is contemplated that the application of the attractant to draw vectors of citrus greening disease may be done in conjunction with other disease management strategies (citrus greening treatment) known in the art for the repelling or killing vectors of citrus greening disease. Other suitable citrus disease management strategies, but are not limited to, insecticide applications (Roger, 2008), biological control agents (Qureshi & Stansly 2007), and/or cultural control options (Childers & Rogers 2005; Powell et al., 2007). Exemplary compositions and methods for treating or preventing citrus greening disease are disclosed, for example, in U.S. Published Patent Application No. 20110021463 and 20100074972.

The attractant may be applied to the outside areas by any suitable method known in the art, such as by spray application, dusting or the like. The application may be done with such quantities and durations to bring about the desired effect. In one embodiment, the application is done by controlled release of the insect attractant through a metered device. In another embodiment where the attractant is at least partially volatile, the attractant may be distributed from a container having a heating element to volatilize the sample, if necessary.

The citrus plants to be aided by the attractants described herein may be any tree or plant that is infected or may be infected with one or more vectors of citrus greening disease. The methods, compositions, and articles of manufacture described herein are suitable for use on any tree or plant that is infected or may be infected with citrus greening disease. Exemplary plants include, by way of example only, any cultivar from the genus Citrus, including but not limited to Citrus sinensis, lemon (C. limon), lime (C. latifolia) grapefruit (C. paradise), sour orange (C. aurantium), and mandarin (C. reticulata).

In an additional embodiment, provided is a method that involves masking signals sent out to insect vectors as a result of the release of methyl salicylate from a disease tree. According to this embodiment, methyl salicylate is administered to a plurality of trees amongst which an infected tree may exist. Since methyl salicylate is released as a result of infection, and this serves as a beacon to attract insect vectors to contribute spread of pathogen to non-infected trees, intentionally applying methyl salicylate across all of the trees will confuse the insect vectors and diminish their ability to find and discern a tree that is infected from a tree that is not infected. This method can be applied across a grove of trees to help ameliorate the spread of pathogen because it significantly decreases the ability of insect vectors to find infected trees and transfer the infection to other trees.

In a specific embodiment related to the preceding, methyl salicylate is administered to a plurality of trees at an amount effect to mask signals from an infected tree. More specifically, the effective may be at an amount that prevents the ability of an insect vector to discern between an infected tree and a non-infected tree. In a particular embodiment, methyl salicylate is administered at a concentration and amount effective to attract insect vectors responsible for spread of citrus greening.

Similar to that described above, the attractant may be applied to the target plants by any suitable method known in the art, such as by spray application, dusting or the like. A slow release matrix, such as wax matrix or microcapsules, may be used. The application may be done with such quantities and durations to bring about the desired effect. In one embodiment, the application is done by controlled release of the insect attractant through a metered device. Examples of metered devices include but are not limited to, spray bottles that are programmed to spray intermittently, or devices that effuse the attractant over a period of time. In another embodiment where the attractant is at least partially volatile, the attractant may be distributed from a container having a heating element to volatilize the sample, if necessary. Thus, applying “to the trees” is to be interpreted as being applied directly on the trees, or in the air around the trees.

The air around a tree would be air in contact with a tree surface or air from contact up to 1-10 feet away.

In an alternative embodiment, methyl salicylate is administered at a concentration and amount effective to repel insect vectors. This would typically be at amounts relatively higher than that effective to attract insect vectors. Those skilled in the art will appreciate that these concentrations and amounts can be achieved in light of the teachings herein.

In yet another aspect of the present invention, there is provided an article of manufacture for dispensing the attractant compositions described herein. The article of manufacture comprises an amount of methyl salicylate effective to attract a plurality of vectors of citrus greening disease. Optionally, the article of manufacture further comprises an agriculturally acceptable carrier. Further, the article of manufacture comprises a container comprising the amount of methyl salicylate and the agriculturally acceptable carrier, if present, and means for applying the amount of methyl salicylate and the agriculturally acceptable carrier from the container to a predetermined area. The means for applying the methyl salicylate may comprise any suitable spray applicator as is known in the art, for example.

In accordance with yet another aspect of the present invention, there is provided a method for preventing or treating infestation of a citrus plant with vectors of citrus greening disease. The method comprises detecting an amount of methyl salicylate associated with the citrus plant. In one embodiment, the amount may be detected by capturing a head space about the subject citrus plant(s) or growth. Thereafter, the amount of methyl salicylate present may be determined by known chromatographic methods, including gas chromatography. The method further requires that, upon detection of methyl salicylate, a citrus greening disease treatment as described above may be applied to the citrus plant in an amount effective to repel or kill the vectors of citrus greening disease by any suitable method as set forth above

The present inventors have also found that there were marked differences between infected and non-infected plants with respect to nutrient content (Table 5 in the Example section). Las-infected plants were deficient in N, P, Mg, Zn, and Fe as compared with non-infected plants (Table 5). However, Las-infected plants had higher K and B contents compared with non-infected plants (Table 5). There were no differences between Las-infected and non-infected plants for Ca, S, Si, Mn, Na, Mo, AL, and Cl. Accordingly, in accordance with another aspect of the present invention, there is provided a method for preventing or treating infestation of a citrus plant with vectors of citrus greening disease that detects the increase/decrease of such minerals in a citrus plant. Upon such detection, a citrus greening disease treatment may be applied to the citrus plant in an amount effective to repel or kill the vectors of citrus greening disease by any suitable method as set forth above.

The following examples are intended for the purpose of illustration of the present invention. However, the scope of the present invention should be defined as the claims appended hereto, and the following examples should not be construed as in any way limiting the scope of the present invention.

### EXAMPLE 1

### Materials and Methods

### Maintenance of Insect, Pathogen and Host Plants

Non-infected adult D. citri used in behavioral bioassays were obtained from a laboratory culture at the University of Florida, Citrus Research and Education Center (Lake Alfred, USA). The culture was established in 2000 from field populations in Polk Co., FL, USA (28.0′N, 81.9′W) prior to the discovery of HLB in FL. The culture was maintained without exposure to insecticides on sour orange (Citrus aurantium L.) and ‘Hamlin’ orange [C. sinensis (L.) Osb.]. Monthly testing of randomly sampled D. citri nymphs, adults, and plants by qPCR was conducted to confirm that psyllids and plants in this culture are free of Las.

Las-infected D. citri were obtained from Las-infected C. aurantium and C. sinensis plants maintained in a secure quarantine facility at the University of Florida, Citrus Research and Education Center. Routine sampling indicated that about 70% of D. citri obtained from this colony were positive for Las when tested in qPCR assays. Both colonies were maintained at 27±1° C., 63±2% RH, and under a L14:D10 hour photoperiod. Non-infected and Las-infected D. citri cultures were maintained in double-screened, 3.7×4.6 m secure enclosures located in separated buildings and with minimal risk of cross contamination.

Las infection in host plants was maintained by graft-inoculation of non-infected C. sinensis with Las-infected key lime (Citrus aurantifolia) budwood collected from citrus groves in Immokalee, Fla., USA. Grafted plants were tested for Las infection by qPCR four months after grafting. Plants that tested positive for Las were used in experiments and for maintenance of Las cultures. Cultures of Las-infected plants were maintained through graft-inoculations because of low transmission efficiency of D. citri adults [17]. Because Las is not seed transmissible [95], Las-free host plants used in experiments were cultivated from C. sinensis seed or obtained as potted seedlings from an HLB-free commercial nursery to minimize the risk of undetectable latent infection of Las in grafted plants. The nursery-obtained plants were confirmed negative for Las infection by qPCR. All infected plants used for experiments exhibited minor or no symptoms, ranging from 0 to 1 on a graded symptom scale of 1 to 10. Non-infected and Las-infected plants were maintained in separate secure enclosures with minimal risk of cross contamination as described above.

Detection of Las in Insect and Plant Samples

Dual-labeled probes were used to detect Las in D. citri and citrus plants using an ABI 7500 system (Applied Biosystems, Foster City, Calif.) in a multiplex TaqMan quantitative real-time polymerase chain reaction (qPCR) assay described in [17,96]. DNA from insect and plant samples was isolated using the DNeasy blood and tissue or DNeasy plant kits (Qiagen Inc, Valencia, Calif.), respectively. Las-specific 16S rDNA from psyllid and plant extracts was amplified using probe-primer sets targeting internal control sequences specific to D. citri [insect wingless] or plant [cytochrome oxidase] gene regions [17,96-97].

DNA amplifications were conducted in 96-well MicroAmp reaction plates (Applied Biosystems). Quantitative PCR reactions consisted of an initial denaturation step of 95° C. for 10 min followed by 40 cycles of 95° C. for 15 s and 60° C. for 60 s. Each 96-well plate containing D. citri samples included a no template control, a positive control (Las DNA in DNA extractions from D. citri), and a negative control (no Las DNA in DNA extractions from D. citri). Likewise, plates containing plant samples included a no template control, a positive control (Las DNA in DNA extractions from plant), and a negative control (no Las DNA in DNA extractions from plant). Reactions were considered positive for either target sequence if the cycle quantification (Cq) value, determined by the ABI 7500 Real-Time software (version 1.4, Applied Biosystems), was ≦32 [17].

### Behavioral Bioassays

A custom designed two-port divided T-olfactometer [Analytical Research Systems (ARS), Inc. Gainesville, Fla.] that has been thoroughly described in [98] was used to evaluate behavioral response of D. citri. Briefly, the olfactometer consisted of a 30 cm long glass tube with 3.5 cm internal diameter that is bifurcated into two equal halves with a Teflon strip forming a T-maze. Each half served as an arm of the olfactometer enabling the D. citri to make a choice between two potential odor fields. The olfactometer arms were connected to odor sources placed in 35 cm tall×15 cm wide dome shaped guillotine volatile collection chambers (GVCC) (ARS, Gainesville, Fla.) through Teflon-glass tube connectors. The odor sources comprised 14-16 week old Las-infected or non-infected C. sinensis plants placed in GVCC. Purified and humidified air was pushed through the GVCC via two pumps connected to an air delivery system (ARS, Gainesville, Fla.). A constant airflow of 0.1 L/min was maintained through both arms of the olfactometer. The olfactometer was housed within a temperature-controlled room and positioned vertically under a fluorescent 900-lux light bulb within a fiberboard box for uniform light diffusion. This positioning took advantage of the negative geotactic and positive phototactic response of D. citri [98].

D. citri adults were released individually into the inlet adapter at the base of the olfactometer. An odor source was randomly assigned to one of the arms of the olfactometer at the beginning of each bioassay and was reversed after every 30 insects to eliminate positional bias. Initially, D. citri adults were exposed to clean air vs. clean air in the olfactometer to verify the absence of positional bias. Thereafter, the behavioral response of non-infected or Las-infected D. citri was tested against non-infected versus Las-infected plants. D. citri adults were also exposed to non-infected grafted (sham grafted) vs. non-grafted-non-infected plants to determine the effects of grafting only on D. citri behavior. For each treatment, C. sinensis plants were grafted with C. aurantifolia budwood four months prior to initiating behavioral experiments. A minimum of 150 male or female D. citri adults were examined per treatment combination (five replications of 30 D. citri). Each D. citri that responded to odors was individually subjected to qPCR to determine Las infection status using the procedures described above.

### Host Plant Selection Under Light or Dark Conditions

Light conditions. To evaluate settling preference of D. citri on non-infected versus Las-infected plants, two non-infected and two Las-infected plants of the similar age (14-16 week old) and vigor were placed randomly into a 0.35×0.35×0.6 m observation cage (Bioquip Products, Rancho Dominguez, USA). Thereafter, 240 D. citri adults (60 per plant) were released into the center of each cage. The cages were housed under temperature-controlled conditions of 27±1° C., 63±2% RH, and under a L14:D10 h photoperiod. There were four cages with each cage representing a single replicate. The total number of D. citri settling on each Las-infected or non-infected citrus plant was recorded three and seven days after release. Experiments were conducted separately and in an identical manner for either non-infected or Las-infected D. citri. Each D. citri adult settling on a non-infected or Las-infected citrus plant was individually tested using qPCR to confirm Las infection status following the procedures described above. Citrus plants used in experiments were examined for Las infection four months after the completion of experiments.

Dark conditions. D. citri use a combination of olfactory and visual cues to locate citrus host plants [37]. Visual cues such as light and color of leaves may impact the settling preference of D. citri for non-infected versus Las-infected citrus plants. Therefore, an experiment was conducted under complete darkness to eliminate the role of visual cues. The materials and procedures were otherwise identical to those described above under light conditions. D. citri adults were counted three and seven days after release using a source of red light. Preliminary testing indicated that red light did not affect psyllid behavior. Furthermore, hemipterans lack red photoreceptors [99].

Movement of D. citri between Las-Infected and Non-Infected Plants

Given that initial orientation of insect vectors to plants could be different from their final settling choices [55] and both could affect pathogen spread, we evaluated movement of D. citri between the Las-infected and non-infected plants. A non-infected or Las-infected plant was inserted at random into an above described observation cage. Thereafter, 60 D. citri adults were confined on this plant using a mesh sleeve for forced settling. Once all psyllids settled on the plant, an additional, randomly selected non-infected or Las-infected plant was inserted into the cage and placed 15 cm away from the initial plant. Immediately thereafter, the mesh sleeve was removed from the initial plant to allow psyllid movement between the two plants. The number of D. citri moving from the initial plant on which they settled and onto the inserted plant was counted seven days after release. Four combinations of plant pairs were examined using either non-infected or Las-infected D. citri for a total of eight treatments. The plant combinations tested were: 1) Las-infected settling plant with a non-infected plant introduction, 2) non-infected settling plant with a Las-infected plant introduction, 3) non-infected settling plant with a non-infected plant introduction, and 4) Las-infected settling plant with a Las-infected plant introduction. The cages were housed in a temperature-controlled room at 27±1° C., 63±2% RH, and under a L14:D10 h photoperiod. Each combination was replicated four times. Non-infected D. citri adults found moving from infected to non-infected plants were individually analyzed for Las infection by qPCR as described above. Thereafter, the inserted non-infected plants were subsequently tested for nutrient status and possible Las infection due to movement of infected psyllids. Only female psyllids were used in these experiments because no differences were observed in behavioral responses between the sexes in preliminary tests.

Feeding Efficiency of D. citri on Non-Infected Versus Infected Plants

One objective of these experiments was to compare feeding efficiency of D. citri adults on Las-infected versus non-infected plants by quantifying their honeydew excretion. Four sets of experiments were conducted to quantify honeydew excretion of psyllids after 24, 48, 72 or 96 hr of feeding. Each experiment was replicated five times. Citrus leaf discs obtained from Las-infected or non-infected plants were placed individually on 1.5% agar beds within 60 mm plastic disposable Petri dishes. Thereafter, ten D. citri adults of mixed age and sex (˜1:1) were released into each dish. Each Petri dish was sealed with lids lined with 60 mm Whatman filter paper (Whatman International Ltd, Kent, UK). Petri dishes were inverted to collect honeydew droplets onto the filter paper. Dishes were maintained at 25±1° C., 50±5% RH, and L14:D10 h photoperiod in an incubator. Collected filter papers were subjected to a ninhydrin (Sigma-Aldrich, St Louis, Mo.) test to facilitate counting of honeydew droplets [100-101]. This technique, developed by Auclair [102], has been successfully used to quantify honeydew excretion by psyllids, whiteflies, aphids and plant hoppers [100-101, 103-104].

Collection and Analysis of Plant Volatiles from Las-Infected or Non-Infected citrus Plants

Infected or non-infected plants, as described above, were confined within a GVCC (ARS, Gainesville, Fla.). Charcoal-purified and humidified air was drawn over plants and pulled out at a rate of 300 mL min-1 through a trap containing 50 mg of Super-Q adsorbent, 800-1000 mesh (Alltech Assoc., Deerfield, Ill., USA) for 24 hrs. Thereafter, Super-Q traps were rinsed with 150 μl of dichloromethane into individual 2.0 ml clear glass vials (Varian, Palo Alto, Calif., USA, part number: 392611549 equipped with 500 μl glass inserts). Volatiles were sampled from two plants simultaneously (one Las-infected and the second non-infected). A total of five plants that were previously identified as infected and five similar plants identified as non-infected were sampled.

Collection of Volatiles from citrus Plants Before and During psyllid Feeding

Volatiles were collected to determine whether release of MeSA was induced by psyllid feeding. Plants were placed within a GVCC with identical flow rates and collection procedures as described above. Volatiles were collected simultaneously from three undamaged plants (no psyllid feeding) for 24 hrs, after which the adsorbent traps were rinsed into vials for gas chromatography-mass spectrometry (GC-MS) analysis. Psyllids were divided by sex and randomly introduced into two of the three plant chambers. Each infested plant received 300 psyllids (one plant receiving only males and another plant receiving only females). The third plant was left uninfested as a control. Volatiles were collected from plants for 24 hr, after which traps were rinsed into vials for GC-MS analysis. Also, volatiles were collected in this manner on three separate dates with six plants evaluated before and after D. citri introduction and three plants serving as simultaneous undamaged controls.

### Analysis of Volatiles by GC-MS

An internal standard of n-octane (300 ng) was added to each sample prior to GC-MS analysis. A one μl aliquot of each extract was injected onto a gas chromatograph (HP 6890) equipped with 30 m×0.25-mm-ID, 0.25 μm film thickness DB-5 capillary column (Quadrex, New Haven, Conn., USA), interfaced to a 5973 Mass Selective Detector (Agilent, Palo Alto, Calif., USA), in both electron impact (EI) and chemical ionization (CI) modes. Helium was used as the carrier gas in the constant flow mode of 30 cm/sec. The injector was maintained at 260° C. The oven was programmed from 40 to 260° C. at 7° C./min. Isobutane was used as the reagent gas for CI, and the ion source temperature was set at 250° C. in CI and 220° C. in EI. The mass spectra were matched with NIST 2005 version 2.0 standard spectra (NIST, Gaithersburg, Md.). The compounds with spectral fit values equal to or greater than 90 and appropriate LRI values were considered positive identifications. When available, mass spectra and retention times were compared to those of authentic standards. Compounds were quantified as equivalents of the total amount of n-octane within each analyzed volatile collection sample. A more accurate quantification of MeSA was made by comparing the total ion chromatograph (TIC) EI response for standard solutions with known quantities of n-octane and MeSA. A response factor of 1.2 was then established for for MeSA relative to the n-octane based values.

Nutritional Status of Las-Infected and Non-Infected citrus Plants

The nutritional status of Las-infected and non-infected citrus plants was analyzed by a commercial laboratory (Waters Agricultural Lab, Inc, Georgia). Leaf samples from 16 qPCR-confirmed Las-infected or non-infected plants were washed, dried and ground to pass a 0.38-mm sieve. An individual leaf sample comprised about three g of dry leaf biomass obtained from three-month-old leaves. Leaf phosphorus, potassium, calcium, magnesium, sulfur, manganese, iron, copper, zinc, boron, silicon, sodium, molybdenum, nitrate, aluminum, and chlorine concentrations were determined by inductively coupled plasma atomic emission spectroscopy.

Behavioral Response of D. citri to Synthetic Chemicals

MeSA was released in greater quantities from Las-infected plants than non-infected plants, while MeAN and D-limonene were released in greater quantities by non-infected than infected plants (See results). Therefore, the behavioral response of D. citri to these synthetic chemicals was tested. A known D. citri attractant, β-ocimene [38], was used as a positive control. All chemicals were obtained from Sigma Aldrich (St Louis, Mo.) with purities ranging between 97 and 99%. Purity of β-ocimene was 90% and contained a mixture of isomers comprising 20-25% limonene. Each treatment was dissolved in 100 μl of dichloromethane and pipetted onto a 2 cm Richmond cotton wick (Petty John Packaging, Inc. Concord, N.C.) at 0.001, 0.01, 0.1, 1.0, 10.0 and 100.0 μg dosages. The control treatment consisted of a cotton wick impregnated with solvent only. The solvent from both treatments was allowed to evaporate within a fume hood for 30 min prior to assays. The bioassay procedures with synthetic chemicals were identical to those described earlier for plant samples. However, in this case, treatments (odor sources) were placed into solid phase micro extraction chambers (SPMEC) (ARS, Gainesville, Fla.) instead of the GVCC described above. The SPMEC consists of a straight glass tube (17.5 cm long×2.5 cm internal diameter) supported with an inlet and outlet valve for incoming and outgoing air streams, respectively [100]. The treated and control cotton wicks were wrapped in laboratory tissue (Kim wipes, Kimberly-Clark, Roswell, Ga.) to minimize contamination and placed randomly into one of the two SPMEC enclosures that were connected to the olfactometer and the air delivery system through Teflon-glass tube connectors.

Only non-infected female psyllids were assayed in these experiments, because no differences in behavioral responses were observed between the sexes or between infected and non-infected psyllids in preliminary tests. At least 120 non-infected female adults were examined per treatment combination. The treatment combinations evaluated in this set of experiment were 1) MeAN vs. clean air, 2) MeSA vs. clean air, 3) D-limonene vs. clean air, and 4) β-ocimene vs. clean air.

### Data Analyses

Chi square (x²) tests were used to compare between the numbers of D. citri entering the treatment or control arm in the T-maze olfactometer. Numbers of D. citri settling on Las-infected versus non-infected citrus plants under light and dark conditions were analyzed using a repeated-measure, mixed-model, factorial analysis of variance (ANOVA) (Proc Mixed, Version 9.1, SAS Institute, Cary, N.C., USA). Las infection status of citrus plants, Las infection status of D. citri, and gender of D. citri were included as fixed effects. Means were compared using Tukey's Honestly Significant Difference (HSD) test. Significant differences in the number of honeydew droplets excreted on Las-infected versus non-infected leaves were analyzed using a two-way ANOVA with Las infection status of leaves and D. citri exposure period as independent factors. Means were compared using Tukey's HSD tests. In assays to determine the movement of D. citri adults between Las-infected and non-infected plants, the number of psyllids moving between the plants was analyzed using one-way ANOVA, followed by means separation using Tukey's HSD test. D. citri adults that did not make a choice were excluded from statistical analyses. The nutrient data obtained from Las-infected versus non-infected plants were analyzed using paired t-tests. In all cases, the significance level was p<0.05.

The resulting volatile profiles were standardized as equivalents of n-octane within each sample analyzed. The characteristic set of variables that defined a particular group (e.g. non-infected versus infected plant) was found using the ‘varSelRFBoot’ function of the package ‘varSelRF’ for the ‘randomForest’ analysis (R software version 2.9.0, R Development Core Team 2009). The varSelRF algorithm was used with Random Forests to select the minimum set of VOCs that were characteristic of differences between infected and non-infected plants. The tree-based Random Forests algorithm performs hierarchical clustering via multi-scale and combinatorial bootstrap resampling and is most appropriate for data where the variables (VOCs in this case) outnumber the samples, and where the variables are auto correlated, which is a typical problem of conventional multivariate analysis of such data. Consequently, this type of analysis is common in bioinformatics, chemoinformatics and similar data-rich fields. Two hundred bootstrapping iterations of the Random Forests algorithm were employed to arrive at a minimal set of VOCs that could differentiate between infected and non-infected plants. The mean decrease in accuracy (MDA) was calculated when individual VOCs are removed from the analysis. MDA values indicate the importance value of particular VOCs for the discrimination between treatments. In addition, treatment differences between individual volatiles collected from headspace of infected and non-infected plants were compared using paired t-tests.

### Results

Response of psyllids to Host Plant Odors

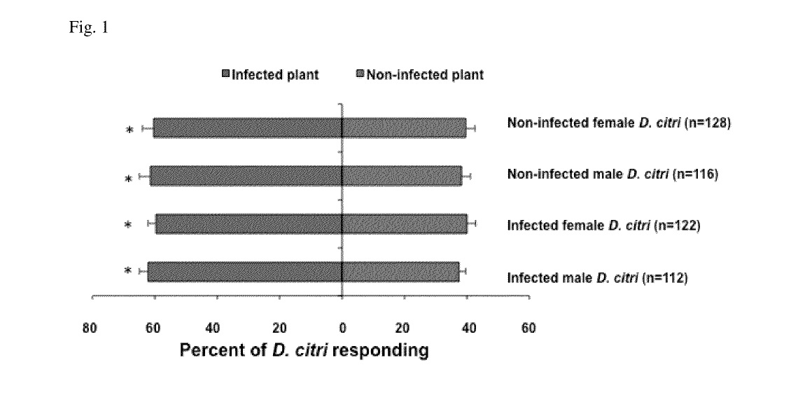

The majority (>80%) of those D. citri tested responded to the odors of either non-infected or Las-infected citrus plants. Significantly more D. citri males (χ²=4.32, df=1, P=0.04) and females (χ²=6.53, df=1, P=0.01) were attracted to the odors from Las-infected plants than non-infected plants (FIG. 1). Las-infected male (χ²=5.24, df=1, P=0.02) and female (χ²=4.37, df=1, P=0.04) psyllids were also more attracted to the odors from infected than non-infected plants (FIG. 1). No significant differences were detected when D. citri adults were exposed to non-infected grafted (sham grafted) vs. non-grafted-non-infected plants.

### Host Plant Selection Under Light or Dark Conditions

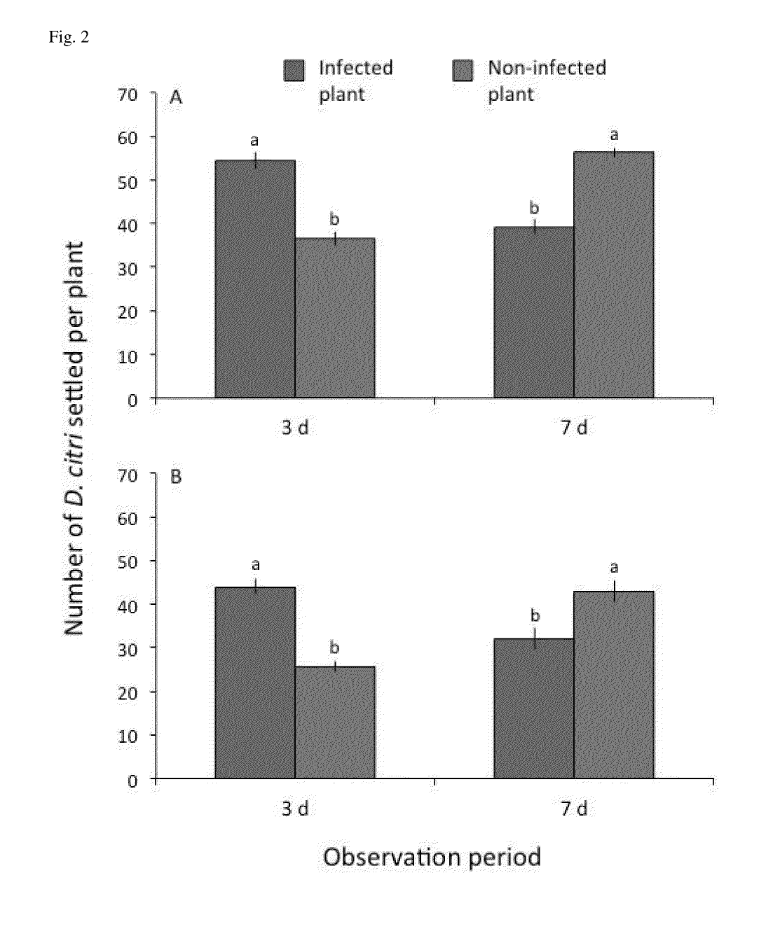

Light conditions. Observation time, Las infection status of D. citri, and gender of D. citri did not significantly affect the number of D. citri that settled on Las-infected versus non-infected plants. Las infection status of plants significantly interacted with observation time (F=160.07, df=1.30, P<0.001). More adult D. citri (of either gender and infection status) landed upon Las-infected plants than on non-infected plants three d after release (FIG. 2A). However, more adult D. citri were found on non-infected plants than on Las-infected plants seven d after release (FIG. 2A). Non-infected plants remained Las-negative when examined four months after exposure to Las-infected or non-infected D. citri in behavioral assays.

Dark conditions. Observation time, Las infection status of D. citri, and gender of D. citri did not significantly affect the number of D. citri that settled on Las-infected versus non-infected plants. Las infection status of plants significantly interacted with observation time (F=49.45, df=1.30, P<0.001). More adult D. citri (of either gender and infection status) landed on Las-infected plants than on non-infected plants three d after release (FIG. 2B). However, more adult D. citri were found on non-infected plants than on Las-infected plants seven d after release (FIG. 2B). Non-infected plants remained Las-negative when examined four months after exposure to Las-infected or non-infected D. citri in behavioral assays.

Movement of D. citri Between Las-Infected and Uninfected Plants

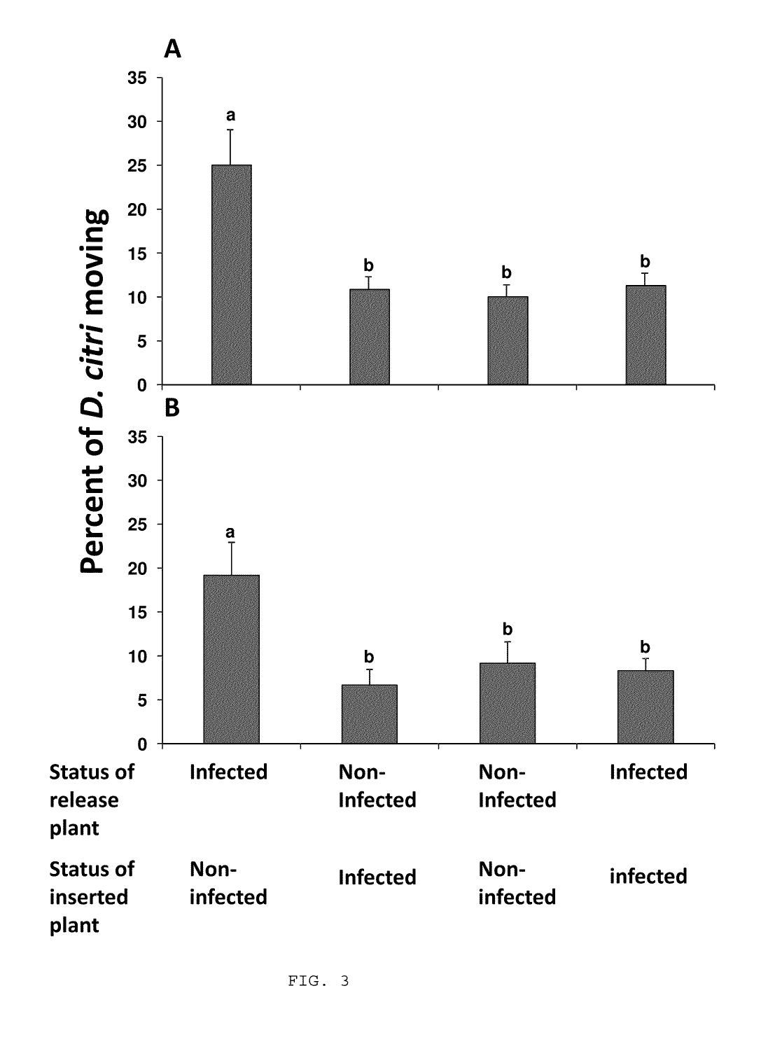

Movement of non-infected or Las-infected D. citri from Las-infected to non-infected plants was greater than observed for any other treatment combination (F=7.69, df=7.24, P<0.0001) (FIG. 3A, B). More Las-infected D. citri tended to move than uninfected counterparts after initial settling, although this difference was not statistically significant. Approximately 5% of non-infected psyllids moving from infected to non-infected plants acquired the Las bacterium (Table 1). Four months after the termination of the experiment, all of the non-infected plants that had been inserted into cages with Las-positive plants tested positive for Las (Table 1). Similarly, all of the non-infected plants inserted into cages with Las-positive plants tested positive for Las when known Las-infected psyllids were used (Table 1).

TABLE 1
Las infection status of inserted plants and Diaphorina citri migrating
from initial point of forced settling to subsequently inserted plant
treatments.

| | | | % of | % of |
|---|---|---|---|---|
| | | | inserted | Las-infected |
| | | Las infection | plants | D. citri on |
| | Inserted | status of | infected | inserted |
| Initial plant | plant | released D. citri | with Las | plants |
| Non-infected | Infected | Non-infected | 100 | 0.0 |
| Non-infected | Infected | Infected | 100 | 71.2 |
| Non-infected | Non-infected | Non-infected | 0.0 | 0.0 |
| Non-infected | Non-infected | Infected | 100 | 68.9 |
| Infected | Infected | Non-infected | 100 | 6.6 |
| Infected | Infected | Infected | 100 | 76.3 |
| Infected | Non-infected | Non-infected | 0.0 | 4.8 |
| Infected | Non-infected | Infected | 100 | 69.7 |

Feeding Efficiency of D. citri on Non-Infected Versus Infected Plants

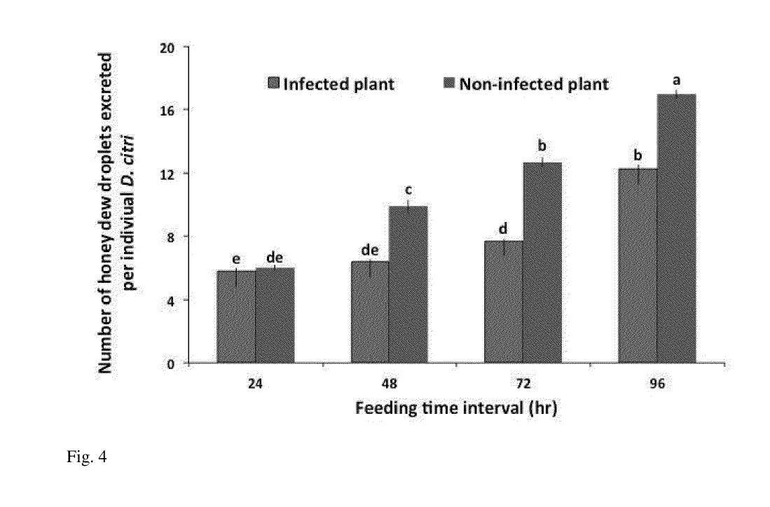

The number of honey dew droplets produced by psyllid feeding, a surrogate measure of feeding efficiency, was significantly affected by the infection status of plants (F=65.99, df=1.39, P<0.0001), feeding exposure time (F=81.81, df=3.24, P<0.0001), and the interaction between the two factors (F=7.11, df=3.28, P=0.0011). There was no significant difference in the amount of feeding on non-infected versus infected plants after 24 h of feeding by psyllids (FIG. 4). However, psyllids fed significantly more on non-infected than on Las-infected plants after 48, 72 and 96 h, respectively.

Volatile Release by Las-Infected and Non-Infected citrus Plants

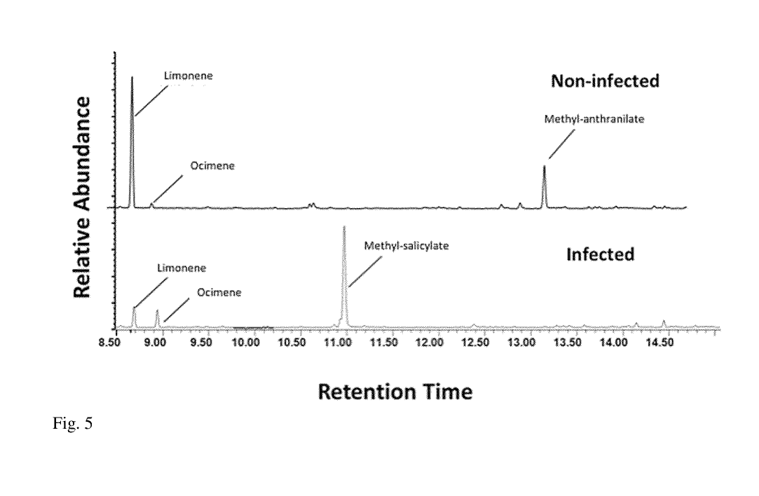

There were significant qualitative and quantitative (Table 2, FIG. 5) differences between the headspace volatiles of non-infected and Las-infected plants (Table 2). Las-infected plants released significantly more MeSA than non-infected plants (Table 2, FIG. 5), while non-infected plants released more methyl anthranilate (MeAN) and D-limonene than infected plants (Table 2). Using a Random Forests algorithm, a minimum of two compounds, MeAN and MeSA, were identified that discriminated between the infected and non-infected volatile organic compound (VOC) signatures of these treatments, with an estimate prediction error of 0.15 and a ‘leave-one-out’ bootstrap error of 0.20.

TABLE 2
Volatiles from Las-infected and non-infected citrus plants presented as
average percentage (±1 SE) of n-octane equivalents of volatile organic compounds
collected from plants' headspace. Each compound is characterized by its retention time
(RT) and major ion.

| | | | | | Las- | | P- |
|---|---|---|---|---|---|---|---|
| Compound | RT | CAS#* | Uninfected | ±SE | infected | ±SE | value |
| Sabiene | 7.94 | 3387-41-5 | 11% | 2.54 | 15% | 0.67 | 0.68 |
| β-pinene | 8.01 | 127-91-3 | >0.01% | >0.001 | >0.01% | >0.001 | 0.89 |
| Myrcene | 8.20 | 123-35-3 | 3% | 0.44 | 3% | 0.23 | 0.84 |
| 3-Carene | 8.57 | 13466-78-9 | 5% | 1.09 | 2% | 0.08 | 0.35 |
| D-limonene | 8.71 | 5989-27-5 | 59% | 3.18 | 27% | 0.79 | 0.02* |
| β-ocimene | 8.95 | 502-99-8 | 6% | 1.01 | 6% | 0.50 | 0.82 |
| Linalool | 9.83 | 78-70-6 | 2% | 0.56 | 1% | 0.11 | 0.72 |
| Menthatriene | 10.14 | 18368- | >0.01% | >0.001 | 4% | 0.25 | 0.13 |
| (1,3,8-para) | | 95-1 | | | | | |
| Methyl | 11.01 | 119-36-8 | 1% | 0.21 | 39% | 2.86 | 0.05* |
| salicylate | | | | | | | |
| Geranial | 12.21 | 141-27-5 | 2% | 0.45 | 0% | 0.0 | 0.15 |
| Methyl | 13.90 | 134-20-3 | 12% | 1.25 | >0.01% | 0.05 | 0.04* |
| anthranilate | | | | | | | |
| Caryophyllene | 14.45 | 87-44-5 | >0.01% | 0.02 | 3% | 0.22 | 0.16 |

Bold values indicate a significant difference between treatments (P < 0.05). The chemicals which were present in different proportions between Las-infected and non-infected citrus plants are shown. Identification was based on comparisons of retention times with standard and spectral data from Adams, EPA, Nist05 Libraries and synthetic standard comparison.
*CAS: Chemical Abstract Service

Volatile Release Before and During psyllid Feeding

MeSA was only detected in headspace volatiles from plants after psyllids were introduced and allowed to feed. It was detected in headspace profiles from plants infested with females as well as males (Table 3). Analysis of the volatile profiles of plants prior to the introduction of psyllids of either sex or from negative control plants yielded no MeSA (Table 3).

TABLE 3
Detection of methyl salicylate release from plants prior to and during
Diaphorina citri feeding.

Presence of
methyl
salicylate

| Treatment | Day 1* | Day 2 |
|---|---|---|
| Female feeding | − | + |
| Male feeding | − | + |
| Undamaged control | − | − |

*Plants sampled on Day 1 were not exposed to psyillds. Samples on Day 2 received 24 h of psyllid feeing.
− indicates no detection while + indicates positive detection of the volatile.

The amount of MeSA released (mean±SE) by plants exposed to psyllid feeding (10.3±3.00 ng/plant/24 hr) was similar to the amount released by Las-infected plants (12.87±4.78 ng/plant/24 hr), and both of these amounts were similar to the quantity of synthetic MeSA found to be attractive to psyllids in behavioral bioassays (Table 4).

TABLE 4
Responses of Diaphorina citri when assayed with synthetic
volatiles identified from Las-infected and non-infected citrus plants.

| | | | Proportion | | |
|---|---|---|---|---|---|
| | | Proportion | of D. citri | | |
| | | of D. citri | responding to | | |
| | Dosage | responding to | control | χ² | P |
| Chemical | (μg) | treatment arm | arm | value | value |
| †β-ocimene | 0.001 | 52.22 | 47.78 | 0.18 | 0.67 |
| (positive | 0.01 | 54.46 | 45.54 | 0.8 | 0.37 |
| control) | 0.1 | 53.19 | 46.81 | 0.38 | 0.54 |
| | 1.0 | 60.44 | 39.56 | 3.97 | 0.05* |
| | 10.0 | 61.46 | 38.54 | 5.04 | 0.02* |
| | 100.0 | 62.77 | 37.23 | 6.13 | 0.01* |
| D-limonene | 0.001 | 56.06 | 43.94 | 0.97 | 0.32 |
| | 0.01 | 60.87 | 39.13 | 2.17 | 0.14 |
| | 0.1 | 54.39 | 45.61 | 0.44 | 0.51 |
| | 1.0 | 54.65 | 45.35 | 0.74 | 0.39 |
| | 10.0 | 60.24 | 39.76 | 3.48 | 0.06 |
| | 100.0 | 61.54 | 38.46 | 4.85 | 0.03* |
| Methyl | 0.001 | 54.00 | 46.00 | 0.32 | 0.57 |
| salicylate | 0.01 | 60.44 | 39.56 | 3.97 | 0.04* |
| | 0.1 | 54.76 | 45.24 | 0.38 | 0.54 |
| | 1.0 | 45.12 | 54.88 | 0.78 | 0.38 |
| | 10.0 | 41.03 | 58.97 | 2.51 | 0.11 |
| | 100.0 | 39.56 | 60.44 | 3.97 | 0.04* |
| Methyl | 0.001 | 58.06 | 41.94 | 0.81 | 0.37 |
| anthranilate | 0.01 | 57.14 | 42.86 | 0.71 | 0.40 |
| | 0.1 | 61.76 | 38.24 | 1.88 | 0.17 |
| | 1.0 | 57.33 | 42.67 | 1.61 | 0.20 |
| | 10.0 | 56.10 | 43.90 | 1.22 | 0.27 |
| | 100.0 | 52.27 | 47.73 | 0.23 | 0.63 |

†β-ocimene carried 20-25% limonene.
P values labeled with * are significantly different (χ² test, P ≦ 0.05).
Rows highlighted in green indicate attraction while rows highlighted in orange indicate repulsion.

Behavioral Response of D. citri to Synthetic Chemicals

Behavioral bioassays with synthetic chemicals identified from Las-infected and non-infected plants revealed that D. citri were attracted to MeSA at the 0.001 μg dosage (χ²=4.85, df=1, p=0.03), but that they were repelled by this chemical at the 100 μg dosage (χ²=4.44, df=1, p=0.04) (Table 4). D. citri were attracted to D-limonene (χ²=4.85, df=1, p=0.03) only at the 100 μg dosage, while MeAN did not attract or repel D. citri at any of the dosages tested. The positive control (β-ocimene) was attractive at 1-100 μg dosages (Table 4).

Nutritional Status of Las-Infected and Non-Infected citrus Plants

There were marked differences between infected and non-infected plants with respect to nutrient content (Table 5). Las-infected plants were deficient in N, P, Mg, Zn, and Fe as compared with non-infected plants (Table 5). However, Las-infected plants had higher K and B contents compared with non-infected plants (Table 5). There were no differences between Las-infected and non-infected plants for Ca, S, Si, Mn, Na, Mo, Al, and Cl.

TABLE 5
Differing levels of various nutrients between Las-infected and non-infected
Citrus sinensis plants.

| Plant status | N | P | K | Mg | Ca | S | B | Zn | Mn | Fe | Si | Na | Mo | Al |
|---|---|---|---|---|---|---|---|---|---|---|---|---|---|---|
| Uninfected plant | 3.13 | 0.17 | 3.00 | 0.43 | 1.88 | 0.25 | 46.67 | 29.33 | 39.00 | 86.33 | 0.15 | 0.08 | 0.02 | 35.34 |
| Las-infected plant | 2.32 | 0.11 | 4.05 | 0.29 | 1.75 | 0.24 | 76.00 | 19.67 | 35.33 | 66.67 | 0.16 | 0.11 | 0.01 | 16.98 |
| T value | 8.03 | 3.72 | 19.10 | 8.67 | 1.67 | 0.42 | 12.35 | 45.85 | 1.21 | 16.75 | 0.43 | 1.69 | 0.42 | 2.08 |
| P value | <0.01* | 0.01 | <0.01* | <0.01* | 0.15 | 0.69 | <0.01* | <0.01* | 0.28 | <0.01* | 0.68 | 0.14 | 0.69 | 0.09 |

Nutrient values in columns labeled with * are significantly different at p < 0.05 (paired t-Test).
Values for N, P, K, Mg, Ca, S, Si, and Na are in % while values for other nutrients are in ppm.

### Discussion

The above results indicate that Las-infected plants were initially more attractive to D. citri adults than non-infected plants; however, psyllids dispersed subsequently to non-infected plants after initially settling on infected plants. Similar results obtained with the behavioral responses of D. citri under both light and dark conditions suggest that initial movement of psyllids to Las-infected plants is likely mediated by volatile cues. Infection of citrus with this plant pathogen induced release of MeSA, which attracted D. citri. A similar amount of MeSA was also released by the trees in response to D. citri infestation, suggesting that the same cue exploited by the pathogen to attract its vector may be used by the vector to locate congregations of conspecifics feeding on non-infected plants. Following initial chemically mediated attraction to infected plants, psyllids tended to subsequently disperse to non-infected plants, making them their preferred settling choice. While not wishing to be bound by theory, this may have been due to the sub-optimal quality of infected plants as compared with non-infected plants, as evidenced by lower feeding efficiency on infected than non-infected leaves. Importantly, this pathogen-manipulated behavioral sequence facilitated pathogen spread by the vector.

The above results further suggest that an insect-transmitted bacterial plant pathogen alters plant traits so as to induce odor-mediated behavior from the vector that may ultimately benefit the pathogen. While increased preference of insect vectors to virus-infected versus non-infected host plants has been demonstrated for both persistently and non-persistently transmitted viruses [3,4,9], little is known about similar interactions involving pathogenic bacteria. Furthermore, prior studies on pathogen-vector interactions have focused on single mechanisms (olfactory, visual or nutritional) [13-14,59-62]. In the current investigation, the inventors sought to determine several underlying mechanisms (chemical, visual, and nutritional) that affect the behavior of an insect (D. citri) in response to plant infection by the pathogen (Candidatus Liberibacter asiaticus) that it transmits.

Volatiles from infected and non-infected citrus are attractive to D. citri as confirmed by the current data and previous studies [38]. D. citri were attracted to common volatiles released by citrus such as β-ocimene and D-limonene, implicating these as general host selection cues. Both β-ocimene and D-limonene are predominant citrus volatiles released by citrus flush, foliage, and fruit [38,63-65]. However, pathogen infection induced release of certain novel components or a quantitative increase in release of certain compounds that were released in lower quantities by non-infected plants. Among the novel chemicals identified that distinguished Las-infected from non-infected plants, only MeSA elicited attraction from D. citri and may explain the enhanced attractiveness of infected plants. Our results, showing induced release of novel volatiles from infected plants, contrast with previous results documenting changes in the ratio of volatiles released after infection by persistently transmitted viruses [3,4,] or an increase in the release of existing volatiles (no change in blend composition) following infection by non-persistent plant viruses [9]. In the current example, bacterial infection of plants induced release of a novel compound (MeSA). MeSA alone elicited attraction from D. citri at a similar concentration at which it was released from Las-infected plants.

Movement of psyllids from infected to non-infected plants after initial selection of infected plants suggests that their initial response to olfactory cues may not be directly linked to the most beneficial host plant. This was also confirmed by feeding assays measured by honeydew excretion. These results suggest that psyllids must feed on infected plants in order to discern poor quality of the host. Therefore, volatiles appear to be involved in host finding, but not in arrestment on the host. Feeding is required for insects to differentiate between non-infected and infected plants and gustatory cues are involved in host acceptance [55,68-69].

Volatile collections from psyllid-infested plants detected induced release of MeSA, suggesting a coincidental convergence on a single cue that may simultaneously benefit the pathogen by deceptively attracting its vector, which also uses this cue to locate conspecifics or identify vulnerable hosts. These results suggest a potential deceptive trade-off for the herbivore. Although plants infested by conspecifics may exhibit compromised defenses, those infected by the pathogen appear to be less suitable than non-infected hosts; however, both phenotypes release nearly the same amount of the MeSA attractant cue. This may explain why our results are not congruent with the recent hypothesis proposed by Mauck et al. [9] that a “deceptive host phenotype” (more attractive, but less suitable) should attract the vector by increasing overall release of attractive volatiles quantitatively instead of producing novel (not released by non-infected plants) cues.

Pathogen-induced release of plant volatiles has been previously established following virus infection. In these cases, CMV, PLRV, and BYDV induced release of volatiles that rendered infected plants more attractive to their aphid vectors than non-infected plants. Both PLRV and BYDV infections improved the quality of the host plants to their respective vectors [3,4,76-77], resulting in preferential arrestment on the infected plants due to contact and gustatory cues [3,4,56] The present results are similar to the findings of Mauck et al [9], where squash plants infected with CMV released volatiles that initially attracted the aphid vector, but were poor hosts for their vectors, causing subsequent movement from infected to non-infected plants. Pathogen-mediated manipulation of vector behavior may depend on how pathogens are transmitted. Persistent pathogens, which require longer feeding durations for acquisition, benefit from increased arrestment of their vector, while non-persistent or semi-persistent pathogens may induce changes in plant phenotype that cause vectors to quickly disperse following acquisition [9]. In the above experiments, psyllids were initially attracted to infected plants, but later preferred to settle on non-infected hosts. Although D. citri were initially attracted to infected plants, which was likely mediated by a volatile cue (consistent with both persistent and non-persistent virus examples [3,9], psyllids preferentially dispersed to non-infected plants after initial feeding on infected ones (consistent with non-persistent virus example [9].

Pathogen spread may be favored in an environment with a low frequency of infected plants, when vectors prefer infected plants [78]. However, in an environment with a high frequency of infected plants, pathogen spread may be favored when vectors prefer non-infected plants [78]. More recent mathematical modeling suggests that when vectors prefer to orient to infected plants, pathogen spread is slow when the frequency of plant infection is low, but pathogen spread is rapid when most plants are infected [55]. Moreover, vector preference for infected versus non-infected plants is partitioned into orientation preference and feeding preference and these two distinct suites of behavior affect pathogen spread differently, depending on whether vectors prefer infected versus non-infected plants [55]. While feeding preference for infected plants may decrease pathogen spread, orientation preference for infected plants may lead to rapid pathogen spread [55]. Acquisition of Las by D. citri can occur after 30 minutes to 24 hr of feeding [28,31]. Therefore, initial landing by psyllids on infected plants for 24 hr or longer is sufficient for acquisition of the pathogen.

Subsequent movement of psyllids from infected to non-infected plants will result in inoculation of new plants as demonstrated by the current results. Therefore, manipulation of D. citri behavior due to Las infection of plants may increase pathogen spread in the field; however, this will likely depend on the frequency of plant infection [55]. The effect of vector preference on pathogen spread depends on several other factors, including the mode of pathogen transmission, latency period, vector movement behavior, and the combined dynamic spatial patterns of the plant, pathogen, and vector [55,78]. Given the apparent convergence on the same attractant cue released in response to Las infection and vector feeding, it is difficult to speculate under what conditions pathogen spread would be favored in the field. Attraction of D. citri to MeSA suggests a possible conflict of interests between the pathogen and the vector. In the early phase of the infection, more conspecifics would be expected to congregate on non-infected plants than on infected plants. Thus, the frequency of non-infected plants releasing MeSA would be greater than the frequency of Las-infected plants releasing this attractant, resulting in greater attraction of psyllids to non-infected plants. Therefore, preferential initial attraction to infected plants may occur either under low population densities of the vector and when the plant infection rate is low, and/or only when the plant infection rate is high.

Furthermore, attraction of vectors to hosts of suboptimal quality suggests another “conflict of interest” [9] between the pathogen and its vector, given that vector performance may be lower on plants, which serve as reservoirs of the pathogen. However, in the D. citri-Las interaction, initial attraction to and subsequent dispersal from infected plants could benefit both the pathogen and vector. Vector feeding on infected host plants promotes acquisition and spread of the pathogen, while infection with the pathogen may have positive effects on vector fitness. Las-infection appears to benefit the fitness of D. citri by increasing fecundity [Pelz-Stelinski, unpublished results].

Las-infected plants were deficient in N, P, Mg, ZN and Fe, but were characterized by higher concentrations of K and B. While not wishing to be bound by theory, it is possible that infected plants are a sub-optimal host for D. citri because of a nutritional imbalance caused by Las infection. Phloem-feeding plant hoppers (Prokelisia dolus) disperse to higher quality Spartina plants when reared on N and P deficient plants [79]. Also, increased N content improves the performance of leaf-feeding aphids (Metopolophium dirhodum) on wheat and barley [80-81]. Physiologically, N is essential for insect growth, survival, and reproduction due to its fundamental role in protein synthesis [82-86]. Phosphorus acts against viral disease by promoting plant maturity, thus restricting pathological effects of virus infection [87]. However, plant nutrient deficiencies can have a negative or positive effect on population dynamics of phloem feeding insects. For example, K deficiency in soybean increases fecundity and population growth of soybean aphid [88-90].

The nutrient analyses described in the current study only addressed the elemental composition of leaf tissues. There may be several other unidentified factors including sugars, amino acids, and proteins that could have contributed to the movement of D. citri from infected to non-infected plants. D. citri feeds specifically within phloem cells, obtaining nutrition from free amino acids, proteins and sugars [26], which are known to affect vector growth [2,69,91-92]. Further comparisons of the elemental composition of psyllids and phloem tissues should help elucidate how host quality affects movement of D. citri. Las-infected leaves have been reported to accumulate up to 7.9-fold more starch than non-infected leaves, resulting in blockage of the phloem vessels [93]; however, the effect of starch accumulation on D. citri nutrition is still unknown. Starch accumulation and callose formation in rice leaves is reported to increase plant resistance to the brown plant hopper, Nilaparvata lugens, by preventing phloem ingestion [94]. In a similar experiment, plants infected with Zucchini yellow mosaic virus (ZYMV) were characterized by lower total protein and sugar content than non-infected plants [69]. However, both ZYMV-infected and non-infected plants had identical total amino acid contents and Aphis gossypii lived longer and produced more offspring on infected than on non-infected plants [69].

In conclusion, Las-infected plants were initially more attractive to D. citri adults than non-infected plants; however, psyllids dispersed subsequently to non-infected plants to make them their preferred location of settling rather than infected plants. The duration of initial setting was sufficient for D. citri to acquire the Las pathogen. Thus, the pathogen may be modifying the behavior of the vector by inducing changes in the attractiveness of the host plant through olfactory cues. This scenario suggests a mechanism for spread of the pathogen in the field because initial attraction and feeding of D. citri on infected host plants should facilitate acquisition of the pathogen, while subsequent movement away from potentially sub-optimal infected plants should facilitate inoculation of non-infected plants. Overall, this behavioral manipulation of the vector by the action of the pathogen on the plant favored spread of the pathogen in a laboratory setting. The present results indicate that MeSA is a specific chemical cue mediating initial psyllid attraction to Las-infected plants.

### REFERENCES

1. Purcell A (1982) Insect vector relationships with procaryotic plant-pathogens. Annual Review of Phytopathology 20: 397-417.
2. Purcell A H (1985) The ecology of bacterial and mycoplasma plant diseases spread by leafhoppers and planthoppers. In: Nault L R, Rodriguez J G, editors, The leafhoppers and planthoppers. New York, J Wiley & Sons pp. 351-380.
3. Eigenbrode S, Ding H, Shiel P, Berger P (2002) Volatiles from potato plants infected with potato leafroll virus attract and arrest the virus vector, Myzus persicae (Homoptera: Aphididae). Proceedings of the Royal Society of London Series B-Biological Sciences 269: 455-460.
4. Jimenez-Martinez E, Bosque-Perez N, Berger P, Zemetra R, Ding H, et al. (2004) Volatile cues influence the response of Rhopalosiphum padi (Homoptera: Aphididae) to barley yellow dwarf virus-infected transgenic and untransformed wheat. Environmental Entomology 33: 1207-1216.
5. Belliure B, Janssen A, Maris P, Peters D, Sabelis M (2005) Herbivore arthropods benefit from vectoring plant viruses. Ecology Letters 8: 70-79.
6. Fereres A, Moreno A (2009) Behavioural aspects influencing plant virus transmission by homopteran insects. Virus Research 141: 158-168.
7. Mann R, Sidhu J, Butter N, Sohi A, Sekhon P (2008) Performance of Bemisia tabaci (Hemiptera: Aleyrodidae) on healthy and cotton leaf curl virus infected cotton. Florida Entomologist 91: 249-255.
8. Mann R S, Sidhu J S, Butter N S (2009) Settling preference of the whitefly Bemisia tabaci (Hemiptera: Aleyrodidae) on healthy versus cotton leaf curl virus-infected cotton plants. International Journal of Tropical Insect Science 29: 57-61.
9. Mauck K, De Moraes C, Mescher M (2010) Deceptive chemical signals induced by a plant virus attracts insect vectors to inferior hosts. Proceedings of the National Academy of Sciences of the United States of America 107: 3600-3605.
10. Daugherty M, Lopes J, Almeida R (2010) Vector within-host feeding preference mediates transmission of a heterogeneously distributed pathogen. Ecological Entomology 35: 360-366.
11. Schoonhoven L (2005) Insect-plant relationships: the whole is more than the sum of its parts. Entomologia Experimentalis et Applicata 115: 5-6.
12. De Boer J, Posthumus M, Dicke M (2004) Identification of volatiles that are used in discrimination between plants infested with prey or nonprey herbivores by a predatory mite. Journal of Chemical Ecology 34: 1045-1049.
13. Mayer C J, Vilcinskas A, Gross J (2008a) Phytopathogen lures its insect vector by altering host plant odor. Journal of Chemical Ecology 34: 1518-1522.
14. Mayer C J, Vilcinskas A, Gross J (2008b) Pathogen-induced release of plant allomone manipulates vector insect behavior. Journal of Chemical Ecology 34: 1518-1522.
15. Koella J C, Srensen F L, Anderson R A (1998) The malaria parasite, Plasmodium falciparum, increases the frequency of multiple feeding of its mosquito vector, Anopheles gambiae. Proceedings of the Royal Society of London Series B, Biological Sciences 265: 763-768.
16. Jiu M, Zhou X P, Liu S S (2006) Acquisition and transmission of two begomoviruses by the B and a non-B biotype of Bemisia tabaci from Zhejiang, China. Journal of Phytopathology 154: 587-591.
17. Pelz-Stelinski K S, Brlansky R H, Ebert T A, Rogers M E (2010) Transmission parameters for Candidatus Liberibacter asiaticus by Asian citrus psyllid (Hemiptera: Psyllidae). Journal of Economic Entomology 103: 1531-1541.
18. Roossinck M J (2011) The good viruses: viral mutualistic symbioses. Nature Reviews Microbiology 9: 99-108.
19. Huang J, Cardoza Y J, Schmelz E A, Raina R, Engelberth J, et al. (2003) Differential volatile emissions and salicylic acid levels from tobacco plants in response to different strains of Pseudomonas syringae. Planta 217: 767-775.
20. Bove J M (2006) Huanglongbing: A destructive, newly-emerging, century-old disease of citrus. Journal of Plant Pathology 88: 7-37.
21. Garnier M, Danel N, Bove J M (1984) Etiology of citrus greening disease. Annales De Microbiologie A135: 169-179.
22. Jagoueix S, Bove J M, Garnier M (1997) Comparison of the 16S/23S ribosomal intergenic regions of “Candidatus Liberobacter asiaticum” and “Candidatus Liberobacter africanum,” the two species associated with citrus huanglongbing (greening) disease. International Journal of Systematic Bacteriology 47: 224-227.
23. Hocquellet A, Toorawa P, Bove J M, Garnier M (1999) Detection and identification of the two Candidatus Liberobacter species associated with citrus huanglongbing by PCR amplification of ribosomal protein genes of the beta operon. Molecular and Cellular Probes 13: 373-379.
24. Sagaram U S, DeAngelis K M, Trivedi P, Andersen G L, Lu S-E, et al. (2009) Bacterial diversity analysis of huanglongbing pathogen-infected citrus, using phylochip arrays and 16S rRNA gene clone library sequencing. Applied and Environmental Microbiology 75: 1566-1574.
25. Christensen N M, Nicolaisen M, Hansen M, Schulz A (2004) Distribution of phytoplasmas in infected plants as revealed by real-time PCR and bioimaging. Molecular Plant-Microbe Interactions 17: 1175-1184.
26. Halbert S E, Manjunath K L (2004) Asian citrus psyllids (Sternorrhyncha: Psyllidae) and greening disease of citrus: A literature review and assessment of risk in Florida. Florida Entomologist 87: 330-353.
27. Lopes S A, Bertolini E, Frare G F, Martins E C, Wulff N A, et al. (2009) Graft transmission efficiencies and multiplication of ‘Candidatus Liberibacter americanus’ and ‘Ca. Liberibacter asiaticus’ in citrus Plants. Phytopathology 99: 301-306.
28. Capoor S P, Rao D G, Viswanath S M (1974) Greening disease of citrus in the Deccan Trap Country and its relationship with the vector, Diaphorina citri Kuwayama. Proceedings of the Sixth Conference of the International Organization of Citrus Virologists: 43-49.
29. Roistacher C N (1991) Greening. In: C N Roistacher editor. Techniques for biological detection of specific citrus graft transmissible diseases. Rome: Food and Agricultural Organization of the United Nations. pp. 35-45.
30. Hung T H, Hung S C, Chen C N, Hsu M H, Su H J (2004) Detection by PCR of Candidatus Liberibacter asiaticus, the bacterium causing citrus huanglongbing in vector psyllids: application to the study of vector-pathogen relationships. Plant Pathology 53: 96-102.
31. Inoue H, Ohnishi J, Ito T, Tomimura K, Miyata S, et al. (2009) Enhanced proliferation and efficient transmission of Candidatus Liberibacter asiaticus by adult Diaphorina citri after acquisition feeding in the nymphal stage. Annals of Applied Biology 155: 29-36.
32. Moll J N, Martin M M (1973) Electron microscope evidence that citrus psylla Trioza-erytreae is a vector of greening disease in South Africa. Phytophylactica 5: 41-44.
33. McClean A P D, Schwarz R E (1970) Greening or blotchy-mottle disease of citrus. Phytophylactica 2: 177-193.
34. Tiwari S, Lewis-Rosenblum H, Pelz-Stelinski K, Stelinski L L (2010) Incidence of Candidatus Liberibacter asiaticus infection in abandoned citrus occurring in proximity to commercially managed groves. Journal of Economic Entomology 103: 1972-1978.
35. Wenninger E J, Hall D G (2007) Daily timing of mating and age at reproductive maturity in Diaphorina citri (Hemiptera: Psyllidae). Florida Entomologist 90: 715-722.
36. Wenninger E J, Hall D G (2008) Importance of multiple mating to female reproductive output in Diaphorina citri. Physiological Entomology 33: 316-321.
37. Wenninger E J, Stelinski L L, Hall D G (2009) Roles of olfactory cues, visual cues, and mating status in orientation of Diaphorina citri Kuwayama (Hemiptera: Psyllidae) to four different host plants. Environmental Entomology 38: 225-234
38. Patt J M, Setamou M (2010) Responses of the Asian citrus psyllid to volatiles emitted by the flushing shoots of its rutaceous host plants. Environmental Entomology 39: 618-624.
39. Pare P W, Tumlinson J H (1999) Plant volatiles as a defense against insect herbivores. Plant Physiology 121: 325-331.
40. Holopainen J K (2004) Multiple functions of inducible plant volatiles. Trends in Plant Science 9: 529-533.
41. Mumm R, Posthumus M A, Dicke M (2008) Significance of terpenoids in induced indirect plant defence against herbivorous arthropods. Plant Cell and Environment 31: 575-585.
42. Walling L L (2000) The myriad plant responses to herbivores. Journal of Plant Growth Regulation 19: 195-216.
43. Kessler A, Baldwin I T (2001) Defensive function of herbivore-induced plant volatile emissions in nature. Science 291: 2141-2144.
44. Kost C, Heil M (2006) Herbivore-induced plant volatiles induce an indirect defence in neighbouring plants. Journal of Ecology 94: 619-628.
45. Stout M J, Thaler J S, Thomma B (2006) Plant-mediated interactions between pathogenic microorganisms and herbivorous arthropods. Annual Review of Entomology 51: 663-689.
46. Wei J, Wang L, Zhu J, Zhang S, Nandi O I, et al. (2007) Plants attract parasitic wasps to defend themselves against insect pests by releasing hexenol. Plos One 2.
47. Liu G, Ji Y, Bhuiyan N H, Pilot G, Selvaraj G, et al. (2010) Amino acid homeostasis modulates salicylic acid-associated redox status and defense responses in Arabidopsis. Plant Cell 22: 3845-3863.
48. Griebel T, Zeier J (2010) A role for beta-sitosterol to stigmasterol conversion in plant-pathogen interactions. Plant Journal 63: 254-268.
49. Mishina T E, Zeier J (2007) Bacterial non-host resistance: interactions of Arabidopsis with non-adapted Pseudomonas syringae strains. Physiologia Plantarum 131: 448-461.
50. Mishina T E, Zeier J (2007) Pathogen-associated molecular pattern recognition rather than development of tissue necrosis contributes to bacterial induction of systemic acquired resistance in Arabidopsis. Plant Journal 50: 500-513.
51. Mishina T E, Griebel T, Geuecke M, Attaran E, Zeier J (2008) New insights into the molecular events underlying systemic acquired resistance. Biology of plant-microbe interactions, Volume 6 Proceedings of the 13th International Congress on Molecular Plant-Microbe Interactions, Sorrento, Italy, 21-27 Jul. 2007: 81.
52. Dean J V, Delaney S P (2008) Metabolism of salicylic acid in wild-type, ugt74f1 and ugt74f2 glucosyltransferase mutants of Arabidopsis thaliana. Physiologia Plantarum 132: 417-425.
53. Attaran E, Zeier T E, Griebel T, Zeier J (2009) Methyl salicylate production and jasmonate signaling are not essential for systemic acquired resistance in Arabidopsis. Plant Cell 21: 954-971.
54. Thaler J S, Agrawal A A, Halitschke R (2010) Salicylate-mediated interactions between pathogens and herbivores. Ecology 91: 1075-1082.
55. Sisterson M S (2008) Effects of insect-vector preference for healthy or infected plants on pathogen spread: Insights from a model. Journal of Economic Entomology 101: 1-8.
56. Srininvasan R, Alvarez J M, Eigenbrode S D, Bosque-Perez N A (2006) Influence of hairy nightshade Solanum sarrachoides (Sendtner) and Potato leafroll virus (Luteoviridae: Polerovirus) on the host preference of Myzus persicae (Sulzer) (Homoptera: Aphididae). Environmental Entomology 35: 546-553.
57. Ngumbi E, Eigenbrode S D, Bosque-Perez N A, Ding H, Rodriguez A (2007) Myzus persicae is arrested more by blends than by individual compounds elevated in headspace of PLRV-Infected potato. Journal of Chemical Ecology 33: 1733-1747.
58. Roder G, Rahier M, Naisbit R E (2011) Do induced responses mediate the ecological interactions between the specialist herbivores and phytopathogens of an alpine plant? PLoS ONE: e19571.
59. Ajayi O, Dewar A M (1983) The effects of barley yellow dwarf virus, aphids and honeydew on cladosporium infection of winter-wheat and barley. Annals of Applied Biology 102: 57-65.
60. Fereres A, Kampmeier G E, Irwin M E (1999) Aphid attraction and preference for soybean and pepper plants infected with potyviridae. Annals of the Entomological Society of America 92: 542-548.
61. Marucci R C, Lopes J R S, Vendramim J D, Corrente J E (2005) Influence of Xylella fastidiosa infection of citrus on host selection by leafhopper vectors. Entomologia Experimentalis Et Applicata 117: 95-103.
62. Strauss E (2009) Phytoplasma research begins to bloom. Science 325: 388-390.
63. Dugo G, Di Giacomo A (2002) Citrus: The genus citrus. medicinal and aromatic plants-industrial profiles series. New York: Taylor & Francis Group, CRC Press. 504p.
64. Jabalpurwala F A, Smoot J M, Rouseff R L (2009) A comparison of citrus blossom volatiles. Phytochemistry 70: 1428-1434.
65. Lin S Y, Roan S F, Lee C L, Chen I Z (2010) Volatile organic components of fresh leaves as indicators of indigenous and cultivated citrus species in Taiwan. Bioscience Biotechnology and Biochemistry 74: 806-811.
66. Webster B, Bruce T J A, Pickett J A, Hardie J (2008) Olfactory recognition of host plants in the absence of host-specific volatile compounds. Communicative and Integrative Biology 1:167-169.
67. Webster B, Bruce T J A, Pickett J A, Hardie J (2010) Volatiles functioning as host cues in a blend become nonhost cues when presented alone to the black bean aphid. Animal Behavior 79:451-457.
68. Macias W, Mink G I (1969) Preference of green peach aphids for virus-infected sugarbeet leaves. Journal of Economic Entomology 62: 28-99.
69. Blua M J, Perring T M (1992) Effects of zucchini yellow mosaic-virus on colonization and feeding-behavior of Aphis-gossypii (Homoptera, Aphididae) alatae. Environmental entomology 21: 578-585.
70. Kaloshian I, Walling L L (2005) Hemipterans as plant pathogens. Annual Review of Phytopathology 43: 491-521.
71. Musser R O, Cipollini D F, Hum-Musser S M, Williams S A, Brown J K, et al. (2005) Evidence that the caterpillar salivary enzyme glucose oxidase provides herbivore offense in Solanaceous plants. Archives of Insect Biochemistry and Physiology 58: 128-137.
72. Ryals J A, Neuenschwander U H, Willits M G, Molina A, Steiner H Y, Hunt M D (1996) Systemic Acquired Resistance. Plant Cell 8: 1809-1819.
73. Durrant W E, Dong X (2004) Systemic acquired resistance. Annual Review of Phytopathology 42:185-209.
74. Zarate S I, Kempema L A, Walling L L (2007) Silverleaf whitefly induces salicylic acid defenses and suppresses effectual jasmonic acid defenses. Plant Physiology 143: 866-875.
75. Walling L L (2008) Avoiding effective defenses: strategies employed by phloem-feeding insects. Plant Physiology 146: 859-866
76. Montllor C B, Gildow F E (1986) Feeding responses of two grain aphids to barley yellow dwarf virus-infected oats. Entomologia Experimentalis et Applicata 42: 63-69.
77. Castle & Berger (1993) Rates of growth and increase of Myzus persicae om virus-infected potatoes according to type of virus-vector relationship. Entomologia Experimentalis et Applicata 69: 51-60.
78. McElhany P, Real, L A, Power A G (1995) Vector preference and disease dynamics: a study of barley yellow dwarf virus. Ecology 76: 444-457.
79. Huberty A F, Denno R F (2006) Consequences of nitrogen and phosphorus limitation for the performance of two planthoppers with divergent life-history strategies. Oecologia 149: 444-455.
80. Honek A (1991) Environment stress, plant-quality and abundance of cereal aphids (hom, aphididae) on winter-wheat. Journal of Applied Entomology-Zeitschrift Fur Angewandte Entomologie 112: 65-70.
81. Honek A (1991) Nitrogen-fertilization and abundance of the cereal aphids Metopolophium dirhodum and Sitobion avenae (Homoptera, Aphididae). Zeitschrift Fur Pflanzenkrankheiten Und Pflanzenschutz-Journal of Plant Diseases and Protection 98: 655-660.
82. Vanemden H F (1966) Studies on relations of insect and host plant .3. a comparison of reproduction of Brevicoryne brassicae and Myzus persicae (hemiptera-aphididae) on brussels sprout plants supplied with different rates of nitrogen and potassium. Entomologia Experimentalis Et Applicata 9: 444-460.
83. Kerslake J E, Woodin S J, Hartley S E (1998) Effects of carbon dioxide and nitrogen enrichment on a plant-insect interaction: the quality of Calluna vulgaris as a host for Operophtera brumata. New Phytologist 140: 43-53.
84. Ayres M P, Wilkens R T, Ruel J J, Lombardero M J, Vallery E (2000) Nitrogen budgets of phloem-feeding bark beetles with and without symbiotic fungi. Ecology 81: 2198-2210.
85. Bentz J A, Townsend A M (2001) Leaf element content and utilization of maple and elm as hosts by the potato leafhopper (Homoptera: Cicadellidae). Environmental Entomology 30: 533-539.
86. Sterner R, Elser J (2002). Ecological stoichiometry: The biology of elements from molecules to the biosphere. New Jersey: Princeton University Press. 584p.
87. Chaboussou F (2004) Healthy crops: A new agricultural revolution. Charlbury, UK: Jon Carpenter Publishing. 244p.
88. Myers S W, Gratton C, Wolkowski R P, Hogg D B, Wedberg J L (2005) Effect of soil potassium availability on soybean aphid (Hemiptera: Aphididae) population dynamics and soybean yield. Journal of Economic Entomology 98: 113-120.
89. Walter A J, DiFonzo C D (2007) Soil potassium deficiency affects soybean phloem nitrogen and soybean aphid populations. Environmental Entomology 36: 26-33.
90. Noma T, Gratton C, Colunca-Garcia M, Brewer M J, Mueller E E, et al. (2010) Relationship of soybean aphid (Hemiptera: Aphididae) to soybean plant nutrients, landscape structure, and natural enemies. Environmental Entomology 39: 31-41.
91. Weibull J, Melin G (1990) Free amino acid content of phloem sap from Brassica plants in relation to performance of Lipaphis erysimi (Hemiptera: Aphididae). Annals of Applied Biology 116: 417-423.
92. Blua M J, Perring T M, and Madore M A (1994) Plant virus-induced changes in aphid population development and temporal fluctuations in plant nutrients. Journal of Chemical Ecology 20: 691-707.
93. Fan J, Chen C, Brlansky R H, Gmitter F G Jr, Li Z G (2010) Changes in carbohydrate metabolism in Citrus sinensis infected with ‘Candidatus Liberibacter asiaticus’. Plant Pathology 59: 1037-1043.
94. Hao P, Liu C, Wang Y, Chen R, Tang M, Du B, Zhu L, He G (2008) Herbivore-induced callose deposition on the sieve plates of rice: An important mechanism for host resistance. Plant Physiology 146: 1810-1820.
95. Hartung J S, Halbert S E, Pelz-Stelinski K S, Brlansky R H, Chen C, Gmitter F G (2010) Lack of evidence for transmission of ‘Candidatus liberibacter asiaticus’ through citrus seed taken from affected fruit. Plant Disease 94: 1200-1205.
96. Li W B, Hartung J S, Levy L (2006) Quantitative real-time PCR for detection and identification of Candidatus Liberibacter species associated with citrus huanglongbing. Journal of Microbiological Methods 66: 104-115.
97. Thao M L, Baumann P (2000) Evolutionary relationships of psyllid endosymbionts based on 16S rDNA, 23S rDNA and atpAGD analyses. Abstracts of the General Meeting of the American Society for Microbiology 100: 632.
98. Mann R S, Rouseff R L, Smoot J M, Castle W S, Stelinski L L (2011) Sulfur volatiles from Allium spp. affect Asian citrus psyllid, Diaphorina citri Kuwayama (Hemiptera: Psyllidae), response to citrus volatiles. Bulletin of Entomological Research 101: 89-97.
99. Briscoe A D, Chittka L (2001) The evolution of color vision in insects. Annual Review of Entomology 46: 471-510.
100. Nauen R, Elbert A (1997) Apparent tolerance of a field-collected strain of Myzus nicotianae to imidacloprid due to strong antifeeding responses. Pesticide Science 49: 252-258.
101. Boina D R, Onagbola E O, Salyani M, Stelinski L L (2009) Antifeedant and sublethal effects of imidacloprid on Asian citrus psyllid, Diaphorina citri. Pest Management Science 65: 870-877.
102. Auclair J L (1959) The influence of dietary amino acids on the blood amino acids of the German cockroach, Blattella germanica (L.). Journal of Insect Physiology 3: 127-31.
103. Paguia P, Pathak M D, Heinrichs E A (1980) Honeydew excretion measurement techniques for determining differential feeding activity of biotypes of Nilaparvata lugens on rice varieties. Journal of Economic Entomology 73: 35-40.
104. Nisbet A J, Woodford J A T, Strang R H C (1994) Quantifying aphid feeding on non-radioactive food sources. Entomologia Experimentalis et Applicata 72: 85-89.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. An insect attractant comprising:
an amount of methyl salicylate effective to attract a plurality of vectors of citrus greening disease; and
an agriculturally acceptable carrier.

2. The insect attractant of claim 1, wherein the vectors comprise at least of D. citri and Triosa erytreae.

3. The insect attractant of claim 1, wherein the vectors are a carrier of the pathogen Candidatus Libreribacter asiaticus.

4. The insect attractant of claim 1, wherein the amount of methyl salicylate in the attractant is from 0.001 μg to 200 μg.

5. The insect attractant of claim 1, further comprising a compound selected from the group consisting of β-ocimene, D-limonene, methyl anthranilate, and combinations thereof.

6. (canceled)

7. A method for inhibiting infestation of a citrus plant by vectors of citrus greening disease, the method comprising:
identifying a target area of desired citrus plant growth; and
applying an amount of an insect attractant comprising methyl salicylate to an area outside of the target area effective to draw the vectors of citrus greening disease away from the target area.

8. The method of claim 7, wherein the area outside of the target area is at least 0.0001 m, 0.1 m, 0.5 m, 1 m, 2 m, 10 m, 50 m, 100 m, or 1000 m from a point on a perimeter of the target area.

9. The method of claim 7, wherein the vectors comprise at least of D. citri and Triosa erytreae.

10. The method of claim 7, wherein the vectors are a carrier of the pathogen Candidatus Libreribacter asiaticus.

11. The method of claim 7, wherein the amount of methyl salicylate in the attractant is from 0.001 μg to 200 μg.

12. The method of claim 7, further comprising a compound selected from the group consisting of β-ocimene, D-limonene, methyl anthranilate, and combinations thereof.

13. (canceled)

14. A method of ameliorating spread of citrus plant pathogen amongst a plurality of trees, said method comprising applying an effective amount of methyl salicylate to the trees, whereby the application of methyl salicylate masks signals from an infected tree.

15. The method of claim 14, wherein said plurality of trees is an orange grove.

16. The method of claim 14, wherein said effective amount of methyl salicylate comprises an amount sufficient to diminish an ability of an insect vector to discern between an infected tree and an non-infected tree.

17. The method of claim 14, wherein the citrus plant pathogen is one that causes citrus greening.

18. The method of claim 14, wherein said effective amount is at a concentration and amount sufficient to attract insect vectors.

19. The method of claim 14, wherein said effective amount is at a concentration and amount sufficient to repel insect vectors.

20. The method of claim 16, wherein the insect vectors comprise at least of D. citri and Triosa erytreae.

21. (canceled)
